(19) United States
(12) Patent Application Publication
(10) Pub. No.: US 2007/0201221 A1
(43) Pub. Date: Aug. 30, 2007

(54) Lighted shoes

(76) Inventors: Eric B. Cherdak, Gaithersburg, MD (US); Brian Jeffrey Cherdak, Fairfax, VA (US)

Correspondence Address: Erik Cherdak, 149 Thurgood St., Gaithersburg, MD, 20878, US

(21) Appl. No.: 11/360,430

(22) Filed: Feb. 24, 2006

(51) Int. Cl. F21V 21/08

(52) U.S. Cl. 362/103; 362/183; 362/192; 36/137

(57) ABSTRACT

A lighted shoe including, but not limited to, a component including, but not limited to, at least one light source (e.g., a light emitting diode or “LED”), and a power generating element (e.g., a magnetic dynamic motor or “dynamo”) used to generate power to illuminate the at least one light source. The lighted shoe need not incorporate a battery to operate the at least one light source.

### BACKGROUND OF THE INVENTION

1. Field of the Invention

The present invention relates to lighted shoes such as lighted or light up shoes for children.

2. Description of Related Art

Lighted shoes are well known. Many designs have been proposed and some have been met with significant commercial success. For example, shoe designers have been very successful in marketing shoes like or similar to those distributed by The Stride Rite Corporation. For example, Stride Rite's Fire Engine lighted shoe (also commonly referred to as an “athletic shoe,” “sneaker,” etc.) includes a single shoe lighting system (one in each shoe of a pair of shoes) that illuminates in response to pressures imparted to shoe during an activity such as during a jump, a step, a running routine, etc. The Fire Engine shoe includes a plurality of light emitting diodes (LEDs) disposed on a decorated side of its upper member. In the heel of the Fire Engine shoe a cavity is formed to house a lighting module—a small, encased structure containing the structural parts that are configured to facilitate lighting. The lighting module includes a battery, a printed circuit board containing a lighting controller, and a spring switch that is configured to open and close based on forces imparted to the shoe during an activity (e.g., a jump, a walking step, jump roping, etc.). The LEDs of the Fire Engine are connected to contact leads or pads on the aforementioned printed circuit board by lead wires that are run through the sole and upper members of the Fire Engine shoe. The lighting module in the Fire Engine and other similar lighting modules in other shoes often have the aforementioned structural configuration.

The typical structural configuration of the Stride Rite Fire Engine as exemplified and described above has been derived after many years of trial and error, failed designs, and in an effort to make devices adhere to certain business constraints limiting commercial success. For example, for many years developers worked to build devices and lighting systems that would not deplete battery life of embedded batteries before a child would outgrow a shoe size. To address battery life, for example, designers have attempted to solve battery depletion problems by increasing battery capacity, designing better switching systems (e.g., pressure responsive spring switches versus mercury switches, etc.), limiting the number of LEDs, controlling illumination sequences, etc. For example, one lighting system that addresses battery depletion problems is shown and described in U.S. Pat. No. 4,848,009 to Rogers. The Rogers design used a timing device to control illumination of LEDs regardless of the operational switch state (OPEN/CLOSED state) of a mercury switch used to cause an LED illumination sequence.

The present invention addresses the issues of battery depletion and exhaustion associated with prior lighting systems used in light up shoes by providing novel batteryless designs as described and claimed in the remaining sections of this patent document. Additionally, the present invention now makes it possible to remove other circuit elements (e.g., controllers, switches, etc.) from shoe lighting systems and continue to achieve appealing light up operation.

### SUMMARY OF THE INVENTION

The present invention provides numerous advantages over prior light up shoes and, in particular, prior lighting systems for shoes including, but not limited to, the advantage of providing a batteryless light up shoe that can be manufactured and marketed very cost effectively.

The present invention provides a lighted shoe including, but not limited to, a component such as at least one light source, a sounding device, etc. and a power generator generating power to illuminate the at least one source in response to movement of the shoe.

The present invention provides a lighted shoe including, but not limited to, at least one light source, and a power generating device used to generate power to illuminate the at least one light source. The power generating device may be configured as a magnetic field induction element that operates in accordance with Faraday's law of electromagnetic induction.

### BRIEF DESCRIPTION OF THE DRAWING FIGURES

The present invention is described in detail below with regard to the attached drawing figures which include:

FIG. 1. is a diagram of a light up shoe having a batteryless lighting system according to a preferred embodiment of the present invention;

FIG. 2 is a block schematic diagram of the lighting system depicted in FIG. 1 along with optional features provided according to a preferred embodiment of the present invention;

FIG. 3 is a plastic encased lighting module of the type that may be incorporated into the light up shoe depicted in FIG. 1;

FIG. 4 is a diagram of a power generator element according to a preferred embodiment of the present invention;

FIG. 5 is a circuit diagram for another preferred embodiment of the present invention; and

FIG. 6 is a circuit diagram for another preferred embodiment of the present invention.

### DETAILED DESCRIPTION OF THE PREFERRED EMBODIMENTS

The present invention is described in detail below with reference to the drawing figures that were briefly described above. Like parts in the drawings are referred to with like reference numerals.

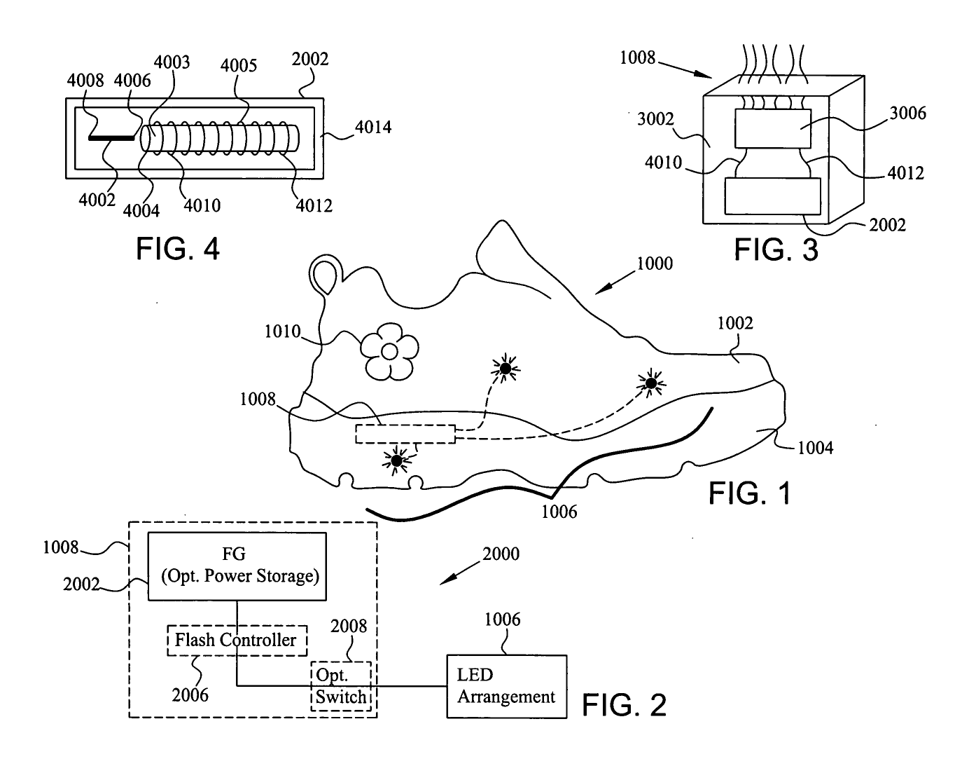

Referring now to FIG. 1, depicted therein is a light up shoe 1000 having a batteryless lighting system according to a preferred embodiment of the present invention. light up shoe 1000 may configured like or similar to the Stride Rite Karly LTT girl's light up shoe which includes an upper member 1002 and a sole member 1004. The construction and design features of light up shoe 1000 will be readily apparent to those skilled in the art.

Disposed so as to be visible to the wearer of light up shoe 1000 (and others) is an LED arrangement 106 (e.g., a light emitting diode arrangement of one or more LEDs which may include LEDs of multiple colors and physical arrangement within the upper of shoe 1000, the sole member of shoe 1000 or in both). Individual LED(s) within LED arrangement 106 are electrically coupled (e.g., connected by lead wires, etc.) to a lighting module 1008. Lighting module 1008 preferably is disposed within a cavity or similar area formed within a portion of the heel of sole member 1004. Alternatively, the components making up lighting module 1008 may be disposed (together or apart) within different parts of shoe 1000. Each LED coupled to lighting module 1008 is typically connected by lead wires to contacts or contact pads of a printed circuit board 3006 (FIG. 3) within lighting module 1008. LED arrangement 106 may involve placement of LEDs about members of light up shoe 1000 such as including, but not limited to, a tongue member, within an aesthetic member 1010 (a flower feature—typically constructed from plastic or other material for adornment of the shoe), etc.

Referring now to FIG. 2, depicted therein is a block schematic diagram of the lighting system depicted in FIG. 1 along with optional features and structures provided according to a preferred embodiment of the present invention. Lighting system 2000 preferably includes a power generator element 2002 which is connected to LEDs of LED arrangement 1006 (FIG. 1). A controller 2006 (in phantom lines) may be included within the circuitry making up lighting system 2000 and be used to facilitate controlled lighting sequences such as controlled LED flash sequences or operations). An optional switch 2008 (in phantom lines) may be included within the circuitry making up lighting system 2000 and be used to further control illumination of LEDs within LED arrangement 1006. If an optional switch 2008 is used, the same may configured in accordance with modern light up shoe switching systems which typically incorporate spring type wiggler momentary contact switches (commonly referred to as “spring switches”) that closes and opens based on pressures (forces per unit area) imparted to the shoes during an activity in which they are housed—such switches are configured to CLOSE momentarily and stay closed a variable amount of time dependent upon the pressures imparted to a shoe during an activity (e.g., during a jump, during a walking step, during a running step, etc.). Accordingly, modern spring type switches used in lighted shoes are pressure responsive switches that operate/actuate based on pressures imparted to the shoes in which they are housed. The phantom lines forming a box around structures 2002, optional controller 2006, and optional switch 2008 illustrate the components which may be housed within an assembly making up a lighting module similar in size and shape to lighting module 1008 (FIG. 1).

Within generator element 2002 may be included a power storage device such as a capacitor or rechargeable battery. Such a power storage device may be used to store unused generated power from generator element 2002 which may be used to power extended lighting cycles within LED arrangement 1006, sound devices if incorporated, etc. For example, a typical red LED may draw 20 mA per typical flash and so additional power may be stored by a capacitor in circuit to facilitate multiple flashes, etc. which may be controlled by controller 2006.

Referring now to FIG. 3, depicted therein is a plastic encased lighting module of the type that may be incorporated into the light up shoe depicted in FIG. 1. As shown in FIG. 3, a plastic or polymer type material may be used to seal the components within lighting module 1008. In particular, in plastic encasement 3002 (which may be formed from epoxy, plastic, or other suitable material, box like and epoxy filled, etc.) may be disposed, power generator element 2002 (which may be separately encased), printed circuit board 3006, lead wires 3004 connecting printed circuit board 3006 and its components to LEDs within LED arrangement 1006 (FIG. 1). Additionally shown are the power leads 4010 and 4012 which emanate from coil ends (discussed below with regard to FIG. 4) to appropriate power pads of printed circuit board 3006. Of course, printed circuit board need not be used especially if only a power generator element according to the present invention is directly coupled to one or more LEDs. The formation of a plastic encased lighting module will be readily apparent to those skilled in the art especially after reviewing the module found in the Stride Rite Karly LTT girl's shoe.

Referring now to FIG. 4, depicted therein is a diagram of the power generator element 2002 depicted in FIG. 1 and discussed above with regard to FIGS. 2 and 3. Power generator element 2002 preferably is configured as a magnetic field induction element that operates in accordance with Michael Faraday's discovery of electromagnetic induction. The Faraday law of electromagnetic induction holds that changes in a magnetic field will induce a current in a nearby circuit. In FIG. 4, a preferred component structure includes a cylindrical or rod-shaped magnet 4002 having, by way of example, a North polarity 4006 and a South polarity 4008. Magnet 4002 may be a neodymium (NdFeB) type permanent magnet. Working in concert with magnet 4002 is coil structure 4004. Coil structure 4004 in this preferred embodiment includes a tubular structure 4003 made from paper, plastic, metal such as iron, etc. about which a metal wire 4005 (e.g., copper wire, etc.) may be coiled in a spring like manner. The present invention may not need tubular structure 4003 to operate. When magnet 4002 is caused to move about coil structure 4004 (an inductor) (e.g., to slide into and out of tubular structure 4003, moved around coil structure 4004, etc.), a voltage (emf) will be induced in coiled metal wire 4005. Changes in the magnetic environment of a coil of wire will cause a voltage (emf) to be “induced” in the coil. No matter how the change is produced, the voltage will be generated. The change could be produced by changing the magnetic field strength, moving a magnet toward or away from the coil, moving the coil into or out of the magnetic field, rotating the coil relative to the magnet, etc. Accordingly, the following principals apply.

[image]

Faraday's law defines a fundamental relationship which comes from Maxwell's equations. It serves as a succinct summary of the ways a voltage (or emf) may be generated by a changing magnetic environment. The induced emf in a coil is equal to the negative of the rate of change of magnetic flux times the number of turns in the coil. It involves the interaction of charge with magnetic field.

[image]

Accordingly, taking a tubular structure 4005 of about % of an inch in length and with a diameter of about ⅛ of an inch and coiling a copper wire about the same say in the range of 30 to 300 times will produce a generator element that will likely yield a sufficient voltage (emf) to drive an LED for one or more visible blinks or multiple LEDs one or more visible blinks when a cylindrically shaped (e.g., a magnetic rod having a round cross section, an oval cross section, a square/rectangle cross section, etc.) permanent magnet having a diameter of less than ⅛ of an inch and a length of about ½ of an inch is caused to move or slide into and out of tubular structure 4005. That it, as so configured a power generator of the aforementioned configuration can generate repeatedly a 20 mA voltage sufficient for a noticeable, human perceptible LED blink. By way of example only, such LEDs blinks are noticeable when they last for a period of time in the range 10 ms to 30 ms but may be configured to last shorter or longer based on particular design requirements and operational characteristics; the range specified is not intended to limit the present invention in any way and is merely an example of a “good” visible LED blink. If a capacitor is used in circuit with such a generator along with a controller various voltages or sufficient voltage may stored depending on LED illumination needs and specifications (e.g., number of blinks, constant on times, number of simultaneous blinks from multiple LEDs, blink duration, etc.). Power generator element 2002 may also be referred to as a magnetic dynamic motor or “dynamo” power source. The dimensions mentioned in this paragraph are merely exemplary and should not be considered as limiting the present invention in any way. If the power generator element 2002 is maintained within an encasement (e.g., sealed in a plastic epoxy member, etc.), for example, to be disposed in a heel cavity of a shoe, for example, the permanent magnet can be made to slide in a formed channel in such encasement that is further disposed in a tubular structure that maintains a coil (spring like structure) to which a voltage will be induced by magnet movement.

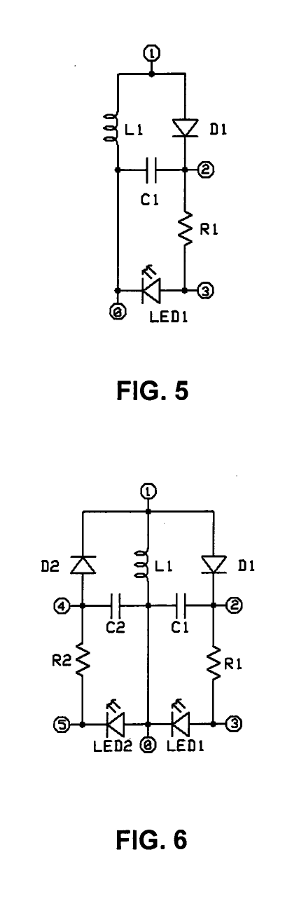

Furthermore, by using a power generator element like or similar to the one described in this patent document, designers of lighted shoes will be able to avoid using batteries, switches and, possibly, controllers (See FIGS. 5 and 6—discussed below). That is, by forming a structure like power generator element 2002 in a plastic structure 4014, magnet 4002 may be configured with sufficient magneticity to slide freely in a channel formed in the inner area or volume of tubular structure 4005, if a tubular structure is used. As a result of the erratic movements of a shoe when worn by a child (movements resulting from each stride of a child's running routine, jumping routine, walking routine, jump-roping routine, etc.), for example, magnet 4002 may be caused to slide back and forth within a channel within tubular structure 4005 so as to induce a voltage in a coil coiled about tubular structure 4005. As such, a power generator element according to the present invention operates as both a motion/acceleration responsive device in place of a pressure responsive spring switch, for example, and a power source to drive LED illumination. Thus, the present invention now simplifies light up shoe technology, reduces the number of components needed to cause LED illumination, reduces costs associated with relatively expensive batteries, enhances reliability of lighting systems thus minimizing product returns to retailers, etc.

It is important to note that although LEDs may be used as the elements that operate in response to power generated by power generator element 2002 (FIG. 2), other circuit elements and devices may be configured to operate with such generated power. For example, audible devices likes sounders, speaker, and buzzers may also be used within a shoe that operate based on generated power which is generated based on movement of a shoe.

Referring now to FIG. 5, depicted therein is a circuit diagram for another preferred embodiment of the present invention. Such a circuit is described for operating one or more LED(s) for the purpose of decoration on a shoe. The circuit utilizes a magnetic dynamic motor or “dynamo” as an energy source. This dynamo will produce energy as a result of the relative motion of a permanent magnet and a stationary inductor, or stator, in the course of the normal conditions of motion of the various parts of a shoe or of the entire shoe itself during such activities as childs' play (e.g., running, jumping, hopscotch, jump rope, etc.).

An aspect of the electricity generating action of the dynamo is the change in the magnetic flux that operates as a magnetic circuit. Work is defined as the time change of flux flowing through the stator inductance. The flux may be generated by any source of magnetic energy, including the earth's own magnetic field. However, a practical implementation would include the use of a suitable permanent magnet such as, for example, an Aluminum Nickel Cobalt (AINiCo) magnet.

In FIG. 5, an exemplary circuit utilizes the dynamo to operate at least one LED. Inductor L1 (L One) is a schematic representation of a coil of wire, often referred to as a solenoid. It may be an air core inductor where the wire is wound around an insulating form or may be a free-form coil without any mechanical support structure. The inductance of the coil however, can be increased by adding a core of a material which increases or concentrates the magnetic flux density due to a higher permeability than that of free space. That is, the permeability of free space, ν₀ is 1. Ferromagnetic materials such as Iron, for example, either metallic or powdered, or compounds such as Ferrite, have relative permeabilities νᵣ much higher than free space. The net effect is to raise the inductance of the stator coil which results in a higher coil voltage in response to a change in magnetic flux.

The terminals of stator inductor are identified as circuit nodes zero (0) and One (1). Node zero will also be referred to as the reference node. Often, the reference node is associated with ground potential; however, the embodiment of this device would likely prohibit connection to an earth ground as the same is maintained in a shoe or other article. Nonetheless, the reference node is the zero voltage potential node to which all other voltages will be referenced.

The direction of the winding of the inductor will be chosen such that when the concentration of magnetic flux in the inductor increases, the voltage potential between nodes zero and one will increase. That is, node one will have a net positive voltage with respect to the reference node.

Worthy of note is that when the inductor has zero change of flux, such as when the shoe is at relative rest (and the magnet does not move relative to the coil), the windings of the coil will have no voltage across them. However, at DC voltage, the inductor looks like a short circuit or, more accurately, a low value resistor. This is due to the low resistance nature of the wire used to wind the inductor.

Device D1 is a rectifier diode located between node one and two. The anode is connected to node one and the cathode to node two. When flux in L1 is increasing, Diode D1 will be in the forward biased or conducting state. This will permit current to flow through the rest of the circuit. Alternatively, when flux is decreasing, the potential of nodes one and two will cause the diode to be reversed biased which will cause the diode to block current flow.

Device C1 is a capacitor. It is connected between nodes zero and two. It is combined with device R1 which is resistor connected between nodes two and three to form a low-pass filter circuit. The capacitor stores electrical energy in the form of an electric field between the two device terminals. Inductor L1 will charge the field of the capacitor with an increase in magnetic flux. When the flux change decreases, Diode D1 prevents the capacitor from discharging into the windings of the inductor.

R1 limits the rate at which current is removed from the charged capacitor C1. Since the circuit affects rate, the circuit operates as a filter with a low pass frequency response. This current is then delivered to LED1 located between nodes three and zero. LED1 operates as a load which converts electrical energy to both light and heat energy.

Referring now to FIG. 6, depicted therein is a circuit diagram of another preferred embodiment of the present invention. Here, the circuit differs from the one depicted in FIG. 5, in that an additional diode D2, Capacitor C2, Resistor R2 and LED1, LED2 are added. These devices are connected in similar fashion to the components in FIG. 5 with the exception that the polarities of D2 and LED2 are reversed. This results in LED2 operating when the flux in inductor L1 is decreasing which results in a net negative voltage between nodes zero and one. The two LEDS will then operate alternatively. In addition to the two LEDs shown in FIG. 6, additional LEDs such as 3, 4, or more, for example, may be connected in series and/or parallel to those shown in FIG. 6 to allow groups of LEDs to flash and to flash alternately. For example, the structure shown in FIG. 6 will allow one or more LEDs to be placed, for example, in a shoe sole member and to have one or more LEDs placed in the shoe's upper member (e.g., on the outstep of the shoe, in a tongue member of the upper), to allow alternate LED blinking upon movement of the shoe. Such alternating blinking, as with all blinking, allows for an eye-appealing lighting sequence.

The circuit in FIG. 6 eliminates the need for a controller (usually in the form of an Integrated Circuit or “IC”), the need for a switch, and a battery. Yet, the device in FIG. 6 can provide visually exciting LED flashing among multiple LEDs much like, but now better than, prior light up shoes. However, because circuit elements may be eliminated, cost of manufacture of lighting modules can decrease as can reduction in product spoilage due to retail-returns of shoes having depleted batteries.

In the embodiments discussed above, the elements of the power generator element, the dynamo, have been shown as parts of a unitary circuit element which may be manufactured and be disposed and maintained within a lighting module that is ultimately fitted into a shoe (e.g., in a heel portion of a shoe—e.g., within a heel cavity formed in a sole member, etc.). The present invention is not so limited and may be modified by placement of inductor and magnet members in different places within a structure in which the present invention is deployed. For example, in the case of a lighted shoe, the inductor (e.g., a coil) may me be disposed in a first, heel area of a sole member and the magnet may be mounted in a second, forward area of the sole member near a toe box portion of the shoe. In this way, power may be generated when the shoe flexes during an activity like walking, running, jumping, etc. and such flexion causes a change in the magnet field associated between the inductor and the magnet that causes sufficient changes in magnetic flux.

The present invention now permits lighting circuits and modules to be made without batteries and other devices (e.g., switches, etc.) that are found in prior systems. As a result, cost of manufacture will decrease in large part as a result of the use of fewer components and less manufacturing time and labor. Additionally, because shoes are often discarded after a period time (such as when they are worn out, no longer fit, etc.), there will be no decaying batteries that often contain materials and chemicals which can be released into the ground in non-environmentally friendly ways—some batteries for example have amounts of mercury which now need not be released into the environment as a result of the novel merits of the present invention.

Additionally, the present invention may be used to charge batteries by use of a power generating element as disclosed herein.

The type of shoes to which the present invention pertains is not limited to those which are like or similar to the ones shown in the drawing figures attached to this patent document. Instead, shoes include footwear like or similar to all sorts of childrens' shoes including sneakers and shoes worn for everyday use, boots, overshoes, overboots, slippers, rubbers, etc. and whether designed for sports, fashion or utilitarian use.

Thus, having fully explained the present invention by way of example and with reference to the attached drawing figures, it will be readily appreciated that many changes and modifications to the present invention may be made without departing from the spirit and scope of the present invention which are further clarified in the appended claims.

What is claimed is:

1. A lighted shoe, comprising:
at least one light source; and
a power generator generating power to illuminate said at least one light source.

2. The lighted shoe according to claim 1, wherein said at least one light source is a light emitting diode (LED).

3. The lighted shoe according to claim 1, further comprising a controller connected to said at least one light source and said power generator, said controller controlling a flashing sequence for said at least one light source.

4. The lighted shoe according to claim 1, wherein said power generator is a dynamo.

5. The lighted shoe according to claim 1, further comprising a capacitor storing power for powering said at least one light source.

6. The lighted shoe according to claim 1, further comprising an upper member in which said at least one light source is mounted to visible from the outside of said lighted shoe.

7. The lighted shoe according, to claim 1, further comprising a sole member in which said at least one light source is mounted to be visible from the outside of said lighted shoe.

8. The lighted shoe according to claim 1, further comprising a sole member and an upper member configured as a footwear article for a child.

9. The lighted shoe according to claim 1, further comprising a sole member having a cavity adapted to maintain said power generator.

10. The lighted shoe according to claim 1, wherein said power generator further comprises an inductor and a permanent magnet, said power generator generating a voltage when said permanent magnet is caused to move relative to said inductor.

11. The lighted shoe according to claim 1, wherein said power generator further comprises an inductor and a permanent magnet, said power generator generating a voltage when said permanent magnet is caused to move relative to said inductor, said inductor and said permanent magnet be disposed in a unitary circuit element.

12. The lighted shoe according to claim 1, wherein said power generator further comprises an inductor and a permanent magnet, said power generator generating a voltage when said permanent magnet is caused to move relative to said inductor, said inductor and said permanent magnet be disposed in separate places within said lighted shoe.

13. The lighted shoe according to claim 12, wherein said inductor is maintained within a first place in a sole member and said permanent magnet is maintained in a second place in said sole member.

14. The lighted shoe according to claim 13, wherein said first place is a heel area of said sole member and said second place is an area near a toe box area of said sole member.

15. A lighted shoe, comprising:
at least one LED; and
a dynamo powering said at least one LED as a result of movement of said lighted shoe.

15. A lighted shoe configured to be worn by a human child, comprising:
a first LED;
a second LED;
a dynamo powering said first and second LEDs in an alternating manner as a result of movement of said lighted shoe.

16. The lighted shoe according to claim 15, wherein said first LED and said second LED emit the same color of light.

17. The lighted shoe according to claim 15, wherein said first LED and said second LED emit light of different colors.

18. The lighted shoe according to claim 15, wherein said first LED actually includes at least one light emitting diode.

19. The lighted shoe according to claim 15, wherein said second LED actually includes at least one light emitting diode.

20. The lighted shoe according to claim 15, wherein said dynamo is constructed as a unitary circuit element maintained within a sole member of said shoe, and said first and second LEDs are connected to said dynamo via lead wires.

21. A shoe comprising:
a power generating element generating power upon movement of the shoe; and
a component connected to said power generating element and configured to operate when powered by said power generating element.

22. The shoe according to claim 21, wherein said component is an LED.

23. The shoe according to claim 21, wherein said component is an audible device.

24. The shoe according to claim 21, wherein said power generating element is a circuit element comprising a magnet structure and a coil structure, said magnet configured to move about a coil structure to generate said power.

25. The shoe according to claim 21, wherein said component includes at least one LED configured to illuminate in response to movement of the shoe.

26. The shoe according to claim 21, further comprising a capacitor configured to store a charge sufficient to operate said component based on a desired pre-configured operational characteristic.

27. The shoe according to claim 26, wherein said operational characteristic is a period of time.

28. The shoe according to claim 27, wherein said period of time is between 10 ms and 30 ms.

29. The shoe according to claim 21, wherein said power generating element is mounted on a printed circuit board having connection points to which said component is electrically connected.

30. The shoe according to claim 29, wherein said printed circuit board is encased in modular object configured to be disposed in a heel portion of said shoe.

31. The shoe according to claim 21, further comprising a battery chargeable by said power generating element.

32. The shoe according to claim 21, further comprising a switch and a controller connected to said controller and to said power generating element, said switch actuable in response to pressures imparted to the shoe during an activity, said controller operating said component when said switch is in a conducting state and said power generating element generates power.
